(19) United States
(12) Patent Application Publication
(10) Pub. No.: US 2026/0222588 A1
(43) Pub. Date: Jul. 30, 2026

(54) ENCODING METHOD, DECODING METHOD AND STORAGE MEDIUM

(71) Applicant: GUANGDONG OPPO MOBILE TELECOMMUNICATIONS CORP., LTD., Dongguan (CN)

(72) Inventor: Hang HUANG, Dongguan (CN)

(21) Appl. No.: 19/578,518

(22) Filed: Mar. 25, 2026

Related U.S. Application Data
(63) Continuation of application No. PCT/CN2023/122658, filed on Sep. 28, 2023.

(51) Int. Cl. H04N 19/14; H04N 19/159; H04N 19/176; H04N 19/186

(52) U.S. Cl. CPC H04N 19/14; H04N 19/159; H04N 19/176; H04N 19/186

(57) ABSTRACT

Encoding and decoding methods and storage medium are provided. The decoding method includes: parsing a bitstream to determine first syntax identification information; if the first syntax identification information indicates that a current block uses a cross-component prediction merge mode, determining second syntax identification information; if the second syntax identification information indicates that the current block uses a cross-component prediction merge fusion mode, determining at least one fusion type identification value corresponding to the current block; determining at least one chroma prediction mode corresponding to the current block according to the fusion type identification value; performing chroma intra prediction on the current block using the chroma prediction mode to determine at least one first prediction value; performing chroma intra prediction on the current block using the cross-component prediction merge mode to determine a second prediction value; determining a chroma prediction value corresponding to the current block based on the prediction values.

### CROSS-REFERENCE TO RELATED APPLICATION

This application is a continuation of International Patent Application No. PCT/CN2023/122658 filed on Sep. 28, 2023, the disclosure of which is hereby incorporated by reference in its entirety.

### BACKGROUND

Based on the reference software test platform of the latest video coding standard H.266/Versatile Video Coding (VVC), the Joint Video Experts Team (JVET) has proposed a new generation of reference software model, namely the Enhanced Compression Model (ECM).

In ECM, the intra prediction part may include luma intra prediction and chroma intra prediction. Here, chroma intra prediction includes a prediction method for a cross-component prediction merge fusion mode. The cross-component prediction merge fusion mode fuses the cross-component prediction merge mode with the default cross-component prediction mode. The fusion method is relatively singular and cannot leverage the advantages of the fusion mode, resulting in low encoding and decoding efficiency.

### SUMMARY

The embodiments of the present disclosure relate to the field of video encoding and decoding technologies, and in particular, to encoding and decoding methods and a storage medium.

The technical solutions of the embodiments of the present disclosure may be implemented as follows:
In a first aspect, an embodiment of the present disclosure provides a decoding method, applied to a decoder. The method includes:
parsing a bitstream to determine a value of first syntax identification information;
if the first syntax identification information indicates that a current block uses a cross-component prediction merge mode, determining a value of second syntax identification information;
if the second syntax identification information indicates that the current block uses a cross-component prediction merge fusion mode, determining at least one fusion type identification value corresponding to the current block;
determining at least one chroma prediction mode corresponding to the current block according to the at least one fusion type identification value;
performing chroma intra prediction on the current block using the at least one chroma prediction mode to determine at least one first prediction value;
performing chroma intra prediction on the current block using the cross-component prediction merge mode to determine a second prediction value; and
determining a chroma prediction value corresponding to the current block based on the at least one first prediction value and the second prediction value.

In a second aspect, an embodiment of the present disclosure provides an encoding method, applied to an encoder. The method includes:
determining a value of first syntax identification information;
if the first syntax identification information indicates that a current block uses a cross-component prediction merge mode, determining a value of second syntax identification information;
if the second syntax identification information indicates that the current block uses a cross-component prediction merge fusion mode, determining at least one chroma prediction mode corresponding to the current block, and determining at least one fusion type identification value corresponding to the at least one chroma prediction mode;
performing chroma intra prediction on the current block using the at least one chroma prediction mode to determine at least one first prediction value;
performing chroma intra prediction on the current block using the cross-component prediction merge mode to determine a second prediction value; and
determining a chroma prediction value corresponding to the current block based on the at least one first prediction value and the second prediction value.

In a third aspect, an embodiment of the present disclosure provides a computer-readable storage medium having stored thereon a computer program and a bitstream wherein when the computer program is executed by a processor, the computer program implements the method of claim 10 to generate a bitstream.

### BRIEF DESCRIPTION OF DRAWINGS

FIG. 1 is a schematic diagram of a current block and adjacent reconstructed chroma pixels and reconstructed luma pixels;

FIG. 2A is a schematic diagram of a linear model based on the CCLM mode;

FIG. 2B is a schematic diagram of a linear model based on the CCLM-SLOPE mode;

FIG. 3 is a schematic diagram of a multi-model based on the MMLM mode;

FIG. 4 is a schematic diagram of spatial components of a convolutional filter based on the CCCM mode;

FIG. 5 is a schematic diagram of a reference template region based on the CCCM mode;

FIG. 6 is a schematic diagram of candidate positions for spatially adjacent blocks;

FIG. 7 is a schematic diagram of candidate positions for spatially non-adjacent blocks;

FIG. 8 is a schematic block diagram of an encoder provided by an embodiment of the present disclosure;

FIG. 9 is a schematic block diagram of a decoder provided by an embodiment of the present disclosure;

FIG. 10 is a schematic diagram of a network architecture of an encoding and decoding system provided by an embodiment of the present disclosure;

FIG. 11 is a first flowchart of a decoding method provided by an embodiment of the present disclosure;

FIG. 12 is a second flowchart of a decoding method provided by an embodiment of the present disclosure;

FIG. 13 is a flowchart of an encoding method provided by an embodiment of the present disclosure;

FIG. 14 is a schematic structural diagram of an encoder provided by an embodiment of the present disclosure;

FIG. 15 is a schematic diagram of a specific hardware structure of an encoder provided by an embodiment of the present disclosure;

FIG. 16 is a schematic structural diagram of a decoder provided by an embodiment of the present disclosure;

FIG. 17 is a schematic diagram of a specific hardware structure of a decoder provided by an embodiment of the present disclosure; and

FIG. 18 is a schematic structural diagram of an encoding and decoding system provided by an embodiment of the present disclosure.

### DETAILED DESCRIPTION

To provide a more detailed understanding of the features and technical content of the embodiments of the present disclosure, the implementation of the embodiments of the present disclosure is described in detail below with reference to the accompanying drawings. The attached drawings are for illustrative purposes only and are not intended to limit the embodiments of the present disclosure.

Unless otherwise defined, all technical and scientific terms used herein have the same meaning as commonly understood by one of ordinary skill in the art to which the present disclosure belongs. The terms used herein are for the purpose of describing the embodiments of the present disclosure only and are not intended to limit the present disclosure.

In the following description, reference is made to “some embodiments,” which describes a subset of all possible embodiments. It should be understood that “some embodiments” may be the same subset or different subsets of all possible embodiments, and may be combined with each other without conflict.

It should also be noted that the terms “first”, “second”, “third”, etc., involved in the embodiments of the present disclosure are only used to distinguish similar objects and do not represent a specific ordering of the objects. It can be understood that “first”, “second”, “third”, etc., may exchange specific order or sequence under permissible circumstances, so that the embodiments of the present disclosure described herein can be implemented in an order other than that illustrated or described herein.

For the purpose of exploring next-generation digital video compression technology, a new generation of reference software model, namely the Enhanced Compression Model (ECM), has been developed based on the reference software test platform of the latest video coding standard H.266/VVC (VVC Test Model, VTM). Currently, video compression technology is also based on traditional block-based encoding and decoding, which may include multiple modules such as block partitioning, intra prediction, inter prediction, transform, quantization, entropy encoding, in-loop and post-processing filtering, etc. The embodiments of the present disclosure mainly improve the prediction part to enhance the encoding performance of ECM.

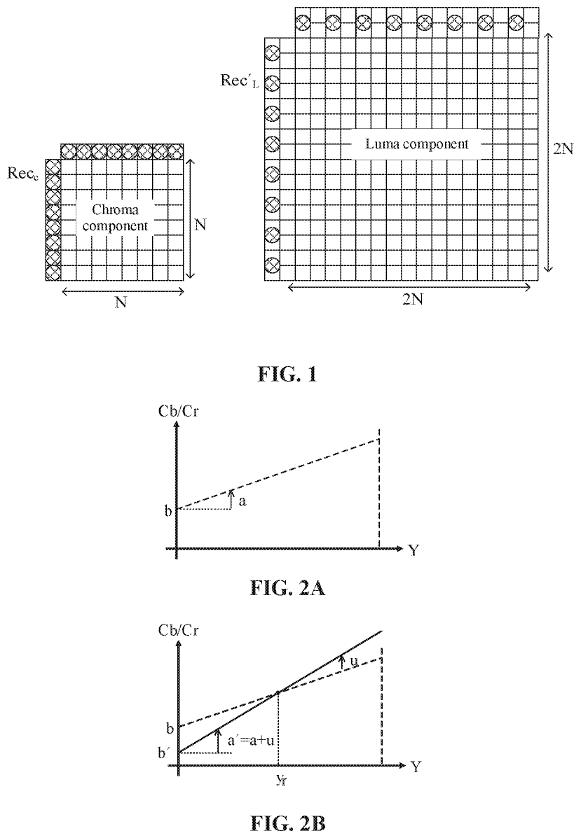

Here, the prediction part may include various technologies, including luma prediction modes and chroma prediction modes. For chroma intra prediction, it can be further divided into cross-component prediction modes and non-cross-component prediction modes. Here, non-cross-component prediction modes typically include Planar mode, Direct Current (DC) mode, Decoder side Intra Mode Derivation (DIMD) mode, etc. For the Cross-Component Linear Model (CCLM) prediction mode, the core idea is to reduce cross-component redundancy and perform cross-component prediction, mainly utilizing the reconstructed luma pixels of the same coding block to construct prediction values for chroma pixels. The linear relationship is shown in the following formula (1):

$${pred}_{C} ( i , j ) = a \cdot {rec}_{L}^{′} ( i , j ) + b \qquad ( 1 )$$

Wherein, pred_{C}(i,j) represents the chroma prediction pixel of the current block, rec_{L}(i,j) represents the downsampled reconstructed luma pixel of the current block; a and b are called linear model parameters. Here, a is the scaling parameter, and b is the offset parameter. a and b can be derived by calculation from adjacent chroma pixels and luma pixels. Since the linear model here can be calculated at both the encoder and the decoder, there is no need to write it into the bitstream. For example, FIG. 1 shows a schematic diagram of the current block and adjacent reconstructed chroma pixels and reconstructed luma pixels in the CCLM mode. As shown in FIG. 1, circles filled with grids represent reference pixels adjacent to the current block that have been reconstructed, which may include left reference pixels and above reference pixels. Additionally, N represents the side length corresponding to the chroma component of the current block, and 2N represents the side length corresponding to the luma component of the current block.

Here, besides using all the above reference pixels and left reference pixels to jointly calculate the parameters of the linear model, there are two other calculation methods for the model parameters, i.e., CCLM has two other modes, called CCLM-T and CCLM-L modes, specifically:
in the CCLM-T mode, only the above reference pixels are used to calculate the linear model parameters;
in the CCLM-L mode, only the left reference pixels are used to calculate the linear model parameters.

To further improve the encoding efficiency of CCLM, many improvements have been made to CCLM in ECM, which may include the CCLM model based on slope (CCLM_SLOPE), Multi-Model Linear Model (MMLM), Convolutional Cross-Component Model (CCCM), Gradient Linear Model (GLM), etc. A brief introduction is given below for some of these linear models.

In CCLM_SLOPE, the calculated linear model parameters can be adjusted. The adjustment method is as follows:

$${a}^{′} = a + u , \qquad ( 2 )$$

$${b}^{′} = b - u * yr$$

Here, the updated linear model parameters a′ and b′ are used to calculate the prediction pixels. Through this improvement, the mapping function is tilted or rotated around the point with luma value yr. Wherein yr is generally the average value of the reference luma pixels. For example, FIG. 2A is a schematic diagram of a linear model based on the CCLM mode, and FIG. 2B is a schematic diagram of a linear model based on the CCLM-SLOPE mode. Here, the horizontal axis represents the reconstructed luma information (Y), and the vertical axis represents the chroma prediction information (Cb/Cr); the model parameters in FIG. 2A are a and b, and the model parameters in FIG. 2B are a′ and b′. Moreover, the model parameters a′ and b′ in FIG. 2B can be obtained by adjusting the model parameters a and b.

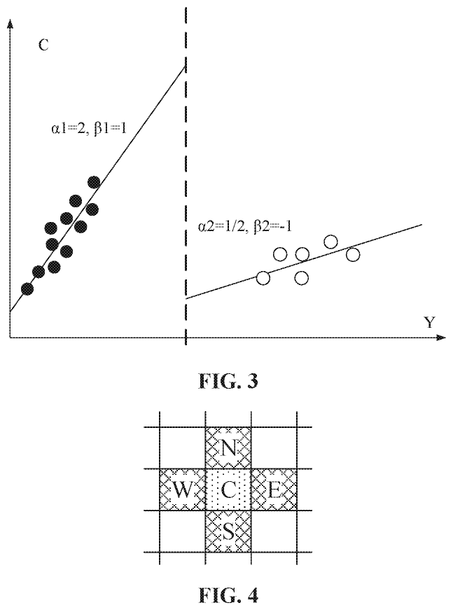

In CCLM, there is only one linear model between the luma and chroma of the same coding block. In MMLM, multiple models can be provided for the same coding block. Adjacent luma and chroma pixels are classified into different categories according to classification thresholds, and pixels in each category are used to derive different model parameters, respectively. For example, FIG. 3 is a schematic diagram of a multi-model based on the MMLM mode. As shown in FIG. 3, adjacent reference pixels are classified according to classification thresholds, and two linear models can be constructed: the model parameters of the first linear model are α1=2, β1=1; the model parameters of the second linear model are α2=½, β2=−1.

For the CCCM cross-component prediction mode, prediction pixels are obtained through a set of convolutional filters. For example, a 7-tap convolutional filter typically contains 5 spatial components as shown in FIG. 4, as well as a nonlinear term and a bias term. The generation of prediction pixels can be as shown in formula (3):

$${pred}_{C} ( i , j ) = {c}_{0} C + {c}_{1} N + {c}_{2} S + {c}_{3} E + {c}_{4} W + {c}_{5} P + {c}_{6} B \qquad ( 3 )$$

Where C represents the luma pixel at pixel position (i,j), and N, S, W, E represent the pixels above, below, to the left, and to the right of the corresponding pixel, respectively. The nonlinear term P represents the 2nd power of the central luma sample C and is scaled to the sample value range of the content. B is the bias term, set to the middle value of the chroma values, i.e., B=midVal. The value of P can be determined by formula (4), as follows:

$$P = ( C * C + midVal ) >> bit Depth \qquad ( 4 )$$

Where bitDepth represents the bit depth, and the value of midVal is determined according to the bit depth value. For example, when the bit depth is 10, the value of midVal is 512.

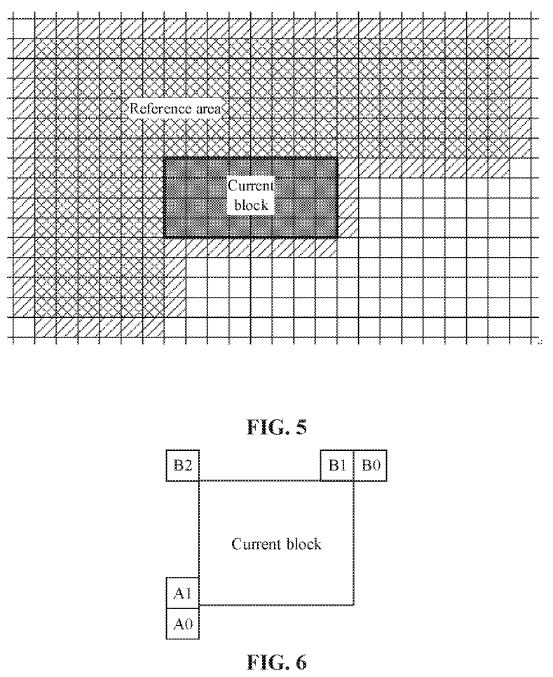

In formula (3), the coefficients of the convolutional filter, such as c₀ to c₆, are determined from adjacent reconstructed pixels. Unlike CCLM, the reference template region for CCCM can be as shown in FIG. 5, including reconstructed pixels in 6 rows and 6 columns around the current block, as well as extended regions in the upper right and lower left. The slashed area outside the reference template region in FIG. 5 represents the extended parts used for spatial components in the convolutional filter. The coefficients of the convolutional filter can be determined by minimizing the Mean-Square Error (MSE) between the prediction in the reference template region and the reconstructed chroma samples. This can be achieved by calculating the autocorrelation matrix of the luma input and the cross-correlation vector between the luma input and the chroma output.

There are also various derivative variants of the cross-component prediction mode based on the convolutional model, including GLM, etc. Similar to CCLM, CCCM can choose to use reference template regions of different shapes, i.e., there exist CCCM-T and CCCM-L modes. Similarly, CCCM can also choose to use multiple parameter models, i.e., the Multi-Model Convolutional Cross-Component Model (MM-CCCM) mode. In the MM-CCCM mode, the current input sample is classified according to a threshold to determine the specific convolutional filter used to obtain the final prediction pixel value.

It can also be understood that for the cross-component prediction merge mode, in the various cross-component linear model prediction modes introduced above, all cross-component model parameters (ccmParam) are derived through calculation from adjacent reconstructed luma pixels and adjacent reconstructed chroma pixels. Based on this, a technique called the cross-component prediction merge mode (Cross-Component Merge, CCMerge) has been proposed. In this mode, the ccmParam for the current block can be directly inherited from reconstructed blocks rather than derived through calculation. A flag cclmMrgFlag indicates whether the current block uses the cross-component prediction merge mode. If the flag cclmMrgFlag is true, i.e., the current block is in CCMerge mode, a model parameter (ccmParam) list can be created for the current block, which can be denoted as ccmList[NUM_LMC_MERGE_CANDS]. This list is populated with existing ccmParam from candidate blocks that are spatially adjacent and spatially non-adjacent. By default, the upper limit for the number of candidates, NUM_LMC_MERGE_CANDS, is 6. When the above process does not fill the list, it can be filled with preset default parameters. The specific model parameter used is indicated by a candidate index cclmMrgIdx.

In some embodiments, the method for populating the candidate list is as follows:

### Step 1: Spatially Adjacent Candidates.

First, check spatially adjacent blocks. The positions of adjacent blocks can be as shown in FIG. 6. The checking order is B1->A1->B0->A0->B2.

### Step 2: Spatially Non-Adjacent Candidates.

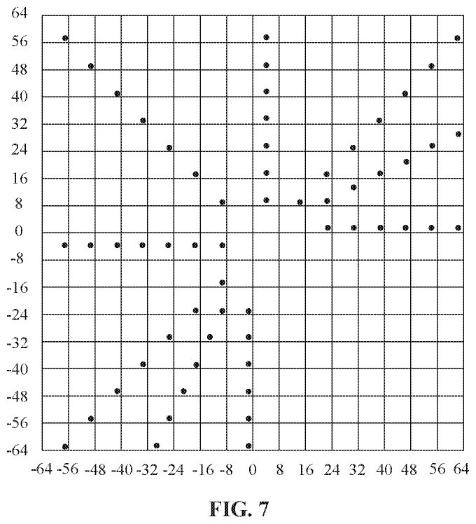

After checking all spatially adjacent blocks, consider spatially non-adjacent blocks. Their positional relationship is as shown in FIG. 7, where each dot represents a non-adjacent block, and each dot indicates the top-left position of that non-adjacent block. It should be noted that the grid in FIG. 7 is only a schematic representation of pixel coordinates and does not represent specific block partitioning.

### Step 3: Default Parameter CCLM Candidates.

If the list is not full, after checking spatially adjacent and non-adjacent candidates, consider CCLM candidates with default scaling parameters. The default scaling parameters are {0, 1/8, −1/8, 2/8, −2/8, 3/8}. If there is a CCLM-type candidate added earlier in the construction process, the scaling parameter a_{first} of the first added CCLM-type candidate is adjusted and added to the candidate list. In this case, the scaling parameters are {0, a_{first}+{1/8, −1/8, 2/8, −2/8, 3/8, −3/8, 4/8, −4/8, 5/8, −5/8, 6/8}}.

For model parameters, the inheritance rules are as follows:
1. When inheriting a CCLM candidate, inherit the scaling parameter and the offset parameter.
2. When inheriting an MMLM candidate, inherit the scaling parameter and the classification threshold.
3. When inheriting a CCCM candidate, inherit all convolution parameters and the classification threshold.
4. When inheriting a GLM candidate, if the GLM is a 3-parameter mode, inherit all gradient indices and model parameters; otherwise, if the GLM is a 2-parameter mode, only inherit the scaling parameter, and the offset parameter needs to be recalculated.
5. When inheriting a chroma fusion mode, the MMLM parameters derived from the cross-component prediction part are inherited as candidates.
6. When inheriting a CCMerge candidate, the inheritance method depends on the candidate mode it inherits.

In the aforementioned cross-component prediction merge mode, the prediction value calculated according to the cross-component prediction merge model is used as the final prediction pixel value. In the fusion mode of the cross-component prediction merge mode, the above prediction value needs to be weighted and fused with the prediction value calculated by the MM-CCCM mode to obtain the final prediction value. The default MM-CCCM mode derives a set of cross-component prediction models based on the reconstructed luma values and reconstructed chroma values adjacent to the current block, calculates a prediction value based on this cross-component prediction model and the pixel values of the luma block corresponding to the current block, and performs weighted fusion with the prediction value generated by the cross-component prediction merge mode to obtain the final prediction value.

It can be seen that the current fusion mode of the cross-component prediction merge mode only performs weighted fusion between the prediction value obtained from the cross-component merge model and the prediction value obtained from the default MM-CCCM, resulting in a relatively singular fusion mode that fails to fully leverage the role of the fusion mode, thereby reducing encoding and decoding efficiency.

Based on this, the embodiments of the present disclosure provide encoding and decoding methods. For the encoding side, at least one chroma prediction mode to be fused with the cross-component prediction merge mode can be determined based on encoding cost, and at least one fusion type identification value corresponding to the at least one chroma prediction mode is sent to the decoding side. When the decoding side determines to use the cross-component prediction merge fusion mode for the current block, it further parses at least one fusion type identification value from the bitstream, performs chroma intra prediction according to the at least one chroma prediction mode corresponding to the at least one fusion type identification value, and fuses the obtained prediction value with the prediction value from the cross-component prediction merge mode as the chroma prediction value corresponding to the current block. Thus, the at least one fusion type identification value can be used to flexibly select the fusion mode on the decoding side, providing multiple choices for the cross-component prediction merge fusion mode, which can improve the prediction accuracy of the cross-component prediction merge fusion mode and thereby enhance encoding and decoding efficiency.

The embodiments will be described in detail below with reference to the accompanying drawings.

Referring to FIG. 8, it shows a schematic block diagram of an encoder provided by an embodiment of the present disclosure. As shown in FIG. 8, the encoder 100 may include a transform and quantization unit 101, an intra estimation unit 102, an intra prediction unit 103, a motion compensation unit 104, a motion estimation unit 105, an inverse transform and inverse quantization unit 106, a filter control analysis unit 107, a filtering unit 108, an encoding unit 109, and a decoded picture buffer unit 110, etc. Here, the filtering unit 108 may implement deblocking filtering and Sample Adaptive Offset (SAO) filtering, and the encoding unit 109 may implement header information encoding and Context-based Adaptive Binary Arithmetic Coding (CABAC). For an input original video signal, a video coding block is obtained through Coding Tree Unit (CTU) partitioning. Then, residual pixel information obtained after intra or inter prediction is transformed by the transform and quantization unit 101, including transforming the residual information from the pixel domain to the transform domain, and quantizing the obtained transform coefficients to further reduce the bit rate; the intra estimation unit 102 and the intra prediction unit 103 are used for intra prediction of the video coding block; specifically, the intra estimation unit 102 and the intra prediction unit 103 are used to determine an intra prediction mode to be used for encoding the video coding block; the motion compensation unit 104 and the motion estimation unit 105 are used to perform inter prediction encoding of the received video coding block relative to one or more blocks in one or more reference frames to provide temporal prediction information; motion estimation performed by the motion estimation unit 105 is a process for producing motion vectors, which can estimate the motion of the video coding block, and then motion compensation is performed by the motion compensation unit 104 based on the motion vectors determined by the motion estimation unit 105; after determining the intra prediction mode, the intra prediction unit 103 is also used to provide the selected intra prediction data to the encoding unit 109, and the motion estimation unit 105 also sends the calculated motion vector data to the encoding unit 109; in addition, the inverse transform and inverse quantization unit 106 is used for reconstructing the video coding block, reconstructing a residual block in the pixel domain, removing block artifact effects from the reconstructed residual block through the filter control analysis unit 107 and the filtering unit 108, and then adding the reconstructed residual block to a predictive block in a frame of the decoded picture buffer unit 110 to produce a reconstructed video coding block; the encoding unit 109 is used to encode various encoding parameters and the quantized transform coefficients. In the CABAC-based encoding algorithm, context may be based on adjacent coding blocks and can be used to encode information indicating the determined intra prediction mode, outputting a bitstream of the video signal; the decoded picture buffer unit 110 is used to store the reconstructed video coding blocks for prediction reference. As video image encoding proceeds, new reconstructed video coding blocks are continuously generated, and these reconstructed video coding blocks are all stored in the decoded picture buffer unit 110.

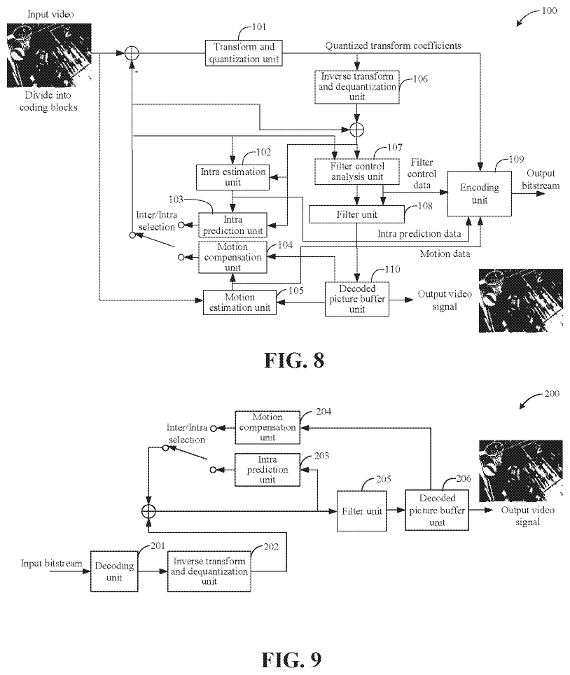

Referring to FIG. 9, it shows a schematic block diagram of a decoder provided by an embodiment of the present disclosure. As shown in FIG. 9, the decoder 200 includes a decoding unit 201, an inverse transform and inverse quantization unit 202, an intra prediction unit 203, a motion compensation unit 204, a filtering unit 205, and a decoded picture buffer unit 206, etc. Here, the decoding unit 201 may implement header information decoding and CABAC decoding, and the filtering unit 205 may implement deblocking filtering and SAO filtering. After the input video signal undergoes the encoding process in FIG. 8, a bitstream of the video signal is output; this bitstream is input into the decoder 200, first passing through the decoding unit 201 to obtain decoded transform coefficients; these transform coefficients are processed by the inverse transform and inverse quantization unit 202 to produce a residual block in the pixel domain; the intra prediction unit 203 can be used to generate prediction data for the current video decoding block based on the determined intra prediction mode and data from previously decoded blocks of the current frame or picture; the motion compensation unit 204 determines prediction information for the video decoding block by parsing motion vectors and other associated syntax elements and uses this prediction information to produce a predictive block for the video decoding block being decoded; a decoded video block is formed by summing the residual block from the inverse transform and inverse quantization unit 202 with the corresponding predictive block produced by the intra prediction unit 203 or the motion compensation unit 204; this decoded video signal passes through the filtering unit 205 to remove block artifact effects, which can improve video quality; then the decoded video block is stored in the decoded picture buffer unit 206, which stores reference images for subsequent intra prediction or motion compensation, and is also used for outputting the video signal, i.e., obtaining the restored original video signal.

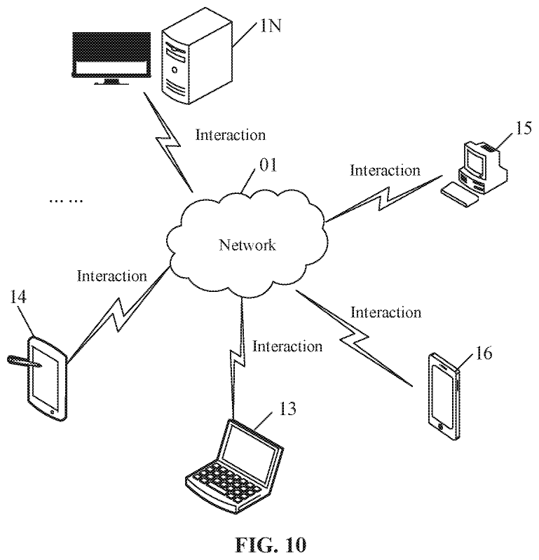

Furthermore, an embodiment of the present disclosure also provides a network architecture of an encoding and decoding system including an encoder and a decoder. FIG. 10 shows a schematic diagram of a network architecture of an encoding and decoding system provided by an embodiment of the present disclosure. As shown in FIG. 10, the network architecture includes one or more electronic devices 13 to 1N and a communication network 01, wherein the electronic devices 13 to 1N can perform video interaction through the communication network 01. In implementation, the electronic devices may be various types of devices with video encoding and decoding functions. For example, the electronic devices may include smartphones, tablet computers, personal computers, personal digital assistants, navigators, digital phones, video phones, televisions, sensing devices, servers, etc., which are not specifically limited in the embodiments of the present disclosure. Here, the decoder or encoder described in the embodiments of the present disclosure may be the aforementioned electronic devices.

It should be noted that the methods of the embodiments of the present disclosure are mainly applied to the prediction part shown in FIG. 8 and the prediction part shown in FIG. 9. That is to say, the embodiments of the present disclosure can be applied to an encoder, a decoder, or even simultaneously to both an encoder and a decoder, but the embodiments of the present disclosure are not specifically limited. Additionally, the prediction part here may include intra prediction and inter prediction parts.

It should also be noted that on the encoding side, the “current block” specifically refers to the current coding block to undergo chroma prediction; on the decoding side, the “current block” specifically refers to the current decoding block to undergo chroma prediction. Here, the current block may be a Coding Unit (CU), a Coding Tree Unit (CTU), or even a Prediction Unit (PU) or Transform Unit (TU), which is not specifically limited here.

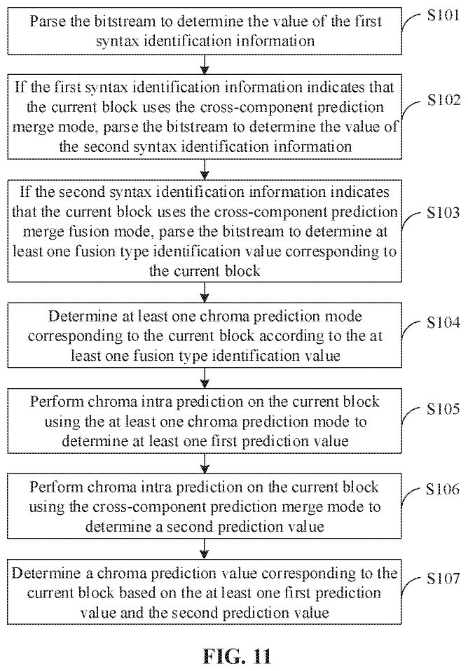

In an embodiment of the present disclosure, referring to FIG. 11, it shows a flowchart of a decoding method provided by an embodiment of the present disclosure. As shown in FIG. 11, the method may include the following steps.
S101: a bitstream is parsed to determine a value of first syntax identification information.
S102: if the first syntax identification information indicates that a current block uses a cross-component prediction merge mode, the bitstream is parsed to determine a value of second syntax identification information.

It should be noted that the decoding method of this embodiment is applied to a decoder. In addition, this decoding method can specifically refer to a chroma prediction method. Among chroma prediction modes, the improvement here is mainly for the cross-component prediction merge mode within chroma intra prediction modes. More specifically, it can be an improvement for the cross-component prediction merge fusion mode within the cross-component prediction merge mode, thereby enhancing the encoding performance of ECM.

It should also be noted that in this embodiment, the first syntax identification information is used to indicate whether the current block uses the cross-component prediction merge mode (CCMerge). In some embodiments, if the value of the first syntax identification information is a first value, it is determined that the first syntax identification information indicates that the current block does not use the cross-component prediction merge mode; if the value of the first syntax identification information is a second value, it is determined that the first syntax identification information indicates that the current block uses the cross-component prediction merge mode. In this embodiment, the first value and the second value are different. Here, the first value and the second value may be in parameter form or numeric form. Specifically, the first syntax identification information here may be a parameter written in the profile, or it may be the value of a flag, which is not specifically limited here.

For example, the first syntax identification information may be denoted as cclmMrgFlag. The first value may be set to 0, and the second value may be set to 1; alternatively, the first value may be set to false, and the second value may be set to true. If cclmMrgFlag is 0, it indicates that the current block does not use the cross-component prediction merge mode. If cclmMrgFlag is 1, it indicates that the current block uses the cross-component prediction merge mode.

That is to say, in this embodiment, if the value of the first syntax identification information is the first value, then it can be determined that the current block does not use the cross-component prediction merge mode. In some embodiments, when the first syntax identification information indicates that the current block does not use the cross-component prediction merge mode, e.g., the value of the first syntax identification information is the first value, chroma intra prediction is performed on the current block through a cross-component prediction mode to determine the chroma prediction value corresponding to the current block. The cross-component prediction mode in this embodiment may include at least one of: cross-component linear model prediction mode, MMLM mode, convolutional cross-component model mode, GLM mode, or chroma fusion mode. Here, the cross-component linear model prediction mode includes at least one of: CCLM mode, CCLM-T mode, or CCLM-L mode; the convolutional cross-component model mode includes at least one of: CCCM mode, CCCM-T mode, or CCCM-L mode. The specific choice is made according to the actual situation, which is not limited in this embodiment.

In this embodiment, if the value of the first syntax identification information is the second value, then it can be determined that the current block uses the cross-component prediction merge mode, and the decoder further parses the bitstream to determine the value of the second syntax identification information.
S103: if the second syntax identification information indicates that the current block uses the cross-component prediction merge fusion mode, the bitstream is parsed to determine at least one fusion type identification value corresponding to the current block.

In this embodiment, the second syntax identification information is used to indicate whether the current block uses the cross-component prediction merge fusion mode. In some embodiments, if the value of the second syntax identification information is a third value, it is determined that the second syntax identification information indicates that the current block does not use the cross-component prediction merge fusion mode; if the value of the second syntax identification information is a fourth value, it is determined that the second syntax identification information indicates that the current block uses the cross-component prediction merge fusion mode. In this embodiment, the third value and the fourth value are different. The third value may be the same as or different from the first value, and the fourth value may be the same as or different from the second value. Here, the third value and the fourth value may be in parameter form or numeric form. Specifically, the second syntax identification information here may be a parameter written in the profile, or it may be the value of a flag, which is not specifically limited here.

For example, the second syntax identification information may be denoted as ccpMergeFusionFlag. The third value may be set to 0, and the fourth value may be set to 1; alternatively, the third value may be set to false, and the fourth value may be set to true. If ccpMergeFusionFlag is 0, it indicates that the current block does not use the cross-component prediction merge fusion mode. If cclmMrgFlag is 1, it indicates that the current block uses the cross-component prediction merge fusion mode.

In some embodiments, when the second syntax identification information indicates that the current block does not use the cross-component prediction merge fusion mode, e.g., ccpMergeFusionFlag is 0, the decoder performs chroma intra prediction on the current block through the cross-component prediction merge mode to determine the chroma prediction value corresponding to the current block.

That is to say, in this embodiment, when the first syntax identification information indicates that the current block uses the cross-component prediction merge mode and the second syntax identification information indicates that the current block uses the cross-component prediction merge fusion mode, it can be determined to use the cross-component prediction merge fusion mode for chroma intra prediction on the current block. The decoder further parses the bitstream to determine at least one fusion type identification value corresponding to the current block. The index identification value is used to indicate at least one chroma prediction mode for performing chroma intra prediction on the current block, in order to perform weighted fusion of the prediction results of the at least one chroma prediction mode with the prediction result of the cross-component prediction merge mode.
S104: at least one chroma prediction mode corresponding to the current block is determined according to the at least one fusion type identification value.

In this embodiment, the decoder and the encoder may agree on a preset correspondence between fusion type identification values and chroma prediction modes. The preset correspondence between fusion type identification values and chroma prediction modes includes at least one preset fusion type identification value corresponding to at least one preset chroma prediction mode. Thus, the decoder can determine at least one chroma prediction mode corresponding to the current block in the preset correspondence according to the at least one fusion type identification value.

For example, at least one preset chroma prediction mode may be identified by at least one preset fusion type identification value in numeric form. Pre-set MM-CCCM mode and Derived Mode (DM) as at least one preset chroma prediction mode, with the preset fusion type identification value for MM-CCCM mode being 0 and the preset fusion type identification value for DM mode being 1. When the decoder parses the bitstream and obtains at least one fusion type identification value of 1, it determines to use the DM mode as the at least one chroma prediction mode to fuse with the cross-component prediction merge mode for prediction results.

In this embodiment, the at least one preset chroma mode may include cross-component prediction modes and non-cross-component prediction modes. In some embodiments, the at least one preset chroma prediction mode includes at least one of: cross-component linear model prediction mode, MMLM mode, convolutional cross-component model mode, GLM mode, DIMD mode, or DM mode. The specific selection is made according to the actual situation and is not limited in this embodiment.
S105: chroma intra prediction is performed on the current block using the at least one chroma prediction mode to determine at least one first prediction value.
S106: chroma intra prediction is performed on the current block using the cross-component prediction merge mode to determine a second prediction value.
S107: a chroma prediction value corresponding to the current block is determined based on the at least one first prediction value and the second prediction value.

In this embodiment, the decoder performs chroma intra prediction on the current block using each chroma prediction mode among the at least one chroma prediction mode to determine a first prediction value corresponding to each chroma prediction mode, thereby determining at least one first prediction value. The decoder performs chroma intra prediction on the current block using the CCMerge mode to determine a second prediction value corresponding to the CCMerge mode. The decoder determines the chroma prediction value corresponding to the current block based on weighted fusion of the at least one first prediction value and the second prediction value.

In some embodiments, the decoder may perform weighted summation on the at least one first prediction value and the second prediction value according to at least two preset weights to determine a weighted sum value; determine a shift factor according to the at least two preset weights, and perform shifting on the weighted sum value according to the shift factor to determine the chroma prediction value.

For example, taking one first prediction value and one second prediction value as an example, fusion can be implemented through formula (5), as follows:

$${pred}_{final} = ( {w}_{1} * {pred}_{ccpMerge} + {w}_{2} * {pred}_{fusionMode} ) >> shift \qquad ( 5 )$$

Where, the at least two weights are w1 and w2, shift represents the shift factor, and the relationship w1+w2=2shift is satisfied. For example, w1 and w2 can be defaulted to 2, then shift is 2. pred_{ccpMerge} epresents the second prediction value corresponding to the cross-component prediction merge mode, and pred_{fusionMode} represents the first prediction value corresponding to the chroma prediction mode determined according to the fusion type identification value.

It should be noted that multiple chroma prediction modes determined according to multiple fusion type identification values can be used. Similar to formula (5), weighted summation and shift processing can be performed on multiple second prediction values corresponding to multiple chroma prediction modes and the first prediction value using multiple weights to determine the chroma prediction value corresponding to the current block. That is to say, this embodiment can achieve fusion of multiple chroma prediction modes.

For example, the fusion type identification value may be at least one value corresponding to a fusion type flag in the bitstream. The fusion type flag may be ccpMergeFusionMode. The at least one preset chroma prediction mode may include a first preset chroma prediction mode and a second preset chroma prediction mode. The preset fusion type identification value corresponding to the first preset chroma prediction mode is 0; the preset fusion type identification value corresponding to the second preset chroma prediction mode is 1. When the value of the second syntax identification information ccpMergeFusionFlag is 1, i.e., the second syntax identification information indicates that the current block uses the cross-component prediction merge fusion mode, it is necessary to further select the corresponding fusion scheme according to the value of ccpMergeFusionMode. If the value of ccpMergeFusionMode is 0, then the first preset chroma prediction mode is selected to generate the first prediction value, which is fused with the second prediction value from the CCMerge mode to generate the final chroma prediction value. If the value of ccpMergeFusionMode is 1, then the second preset chroma prediction mode is selected to generate the first prediction value, which is fused with the second prediction value from the CCMerge mode to generate the final chroma prediction value.

When the value of the second syntax identification information ccpMergeFusionFlag is 0, it indicates that the cross-component prediction merge fusion mode is not used, and there is no need to decode the ccpMergeFusionMode flag.

In some possible embodiments, the aforementioned first preset chroma prediction mode may be the MM-CCCM mode, and the aforementioned second preset chroma prediction mode may be the MMLM mode. An example of this embodiment applied to the cross-component prediction merge fusion mode is as follows:

When the decoder parses that the value of ccpMergeFusionFlag for the current block is 1, the at least one chroma prediction mode to be fused with the CCMerge mode for prediction results is determined according to the value of the flag ccpMergeFusionMode.

If the value of ccpMergeFusionMode is 0, the chroma prediction mode to be fused with the CCMerge mode is set to MM-CCCM. Chroma intra prediction is performed according to the steps of the MM-CCCM mode to determine the first prediction value. The first prediction value is weighted and fused with the second prediction value generated by the CCMerge mode to obtain the chroma prediction value of the current block.

If the value of ccpMergeFusionMode is 1, the chroma prediction mode to be fused with the CCMerge mode is set to MMLM. Chroma intra prediction is performed according to the steps of the MMLM mode to determine the first prediction value. The first prediction value is weighted and fused with the second prediction value generated by the CCMerge mode to obtain the chroma prediction value of the current block.

In other possible embodiments, the aforementioned first preset chroma prediction mode may be the MM-CCCM mode, and the second preset chroma prediction mode may be the DIMD mode. An example of this embodiment applied to the cross-component prediction merge fusion mode is as follows:

When the decoder parses that the value of ccpMergeFusionFlag for the current block is 1, the at least one chroma prediction mode to be fused with the CCMerge mode for prediction results is determined according to the value of the flag ccpMergeFusionMode.

If the value of ccpMergeFusionMode is 0, the chroma prediction mode to be fused with the CCMerge mode is set to MM-CCCM. Chroma intra prediction is performed according to the steps of the MM-CCCM mode to determine the first prediction value. The first prediction value is weighted and fused with the second prediction value generated by the CCMerge mode to obtain the chroma prediction value of the current block.

If the value of ccpMergeFusionMode is 1, the chroma prediction mode to be fused with the CCMerge mode is set to DIMD mode. The corresponding intra prediction angular mode is derived according to the steps of the DIMD mode to generate the first prediction value. The first prediction value is weighted and fused with the second prediction value generated by the CCMerge mode to obtain the chroma prediction value of the current block.

It can be understood that when the current block uses the cross-component prediction merge mode, the decoder further determines that the current block uses the cross-component prediction merge fusion mode, can further parse at least one fusion type identification value corresponding to the current block from the bitstream, determines at least one chroma prediction mode corresponding to the current block according to the at least one fusion type identification value, and then fuses the at least one first prediction value obtained through prediction using the at least one chroma prediction mode with the second prediction value obtained through prediction using the cross-component prediction merge mode to determine the chroma prediction value corresponding to the current block. That is to say, based on the at least one fusion type identification value, the fusion mode on the decoding side can be flexibly selected, providing multiple choices for the cross-component merge fusion mode prediction, thereby improving the prediction accuracy of the cross-component prediction merge fusion mode and further enhancing decoding efficiency.

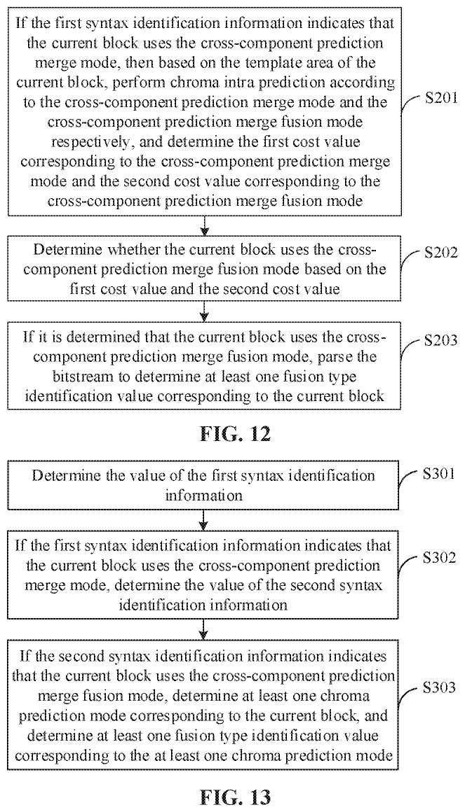

In some embodiments, based on FIG. 11, as shown in FIG. 12, after S101 and before S102, S201-S203 may also be performed, as follows.
S201: if the first syntax identification information indicates that the current block uses the cross-component prediction merge mode, then based on a template region of the current block, chroma intra prediction is performed according to the cross-component prediction merge mode and the cross-component prediction merge fusion mode respectively, to determine a first cost value corresponding to the cross-component prediction merge mode and a second cost value corresponding to the cross-component prediction merge fusion mode.

In this embodiment, if the first syntax identification information indicates that the current block uses the cross-component prediction merge mode, a template region corresponding to the current block can be determined. For example, T rows and T columns (T is an integer not less than 1, e.g., T equals 3) of pixels in the reconstructed area around the current block can be taken as the template region. Understandably, the template region includes reconstructed blocks around the current block. The decoder performs chroma intra prediction on the template region based on the cross-component prediction merge mode and the cross-component prediction merge fusion mode, respectively.

In this embodiment, the encoder uses the cross-component prediction merge mode for prediction on the template region, and determines the first cost value corresponding to the cross-component prediction merge mode based on the prediction value corresponding to the cross-component prediction merge mode and the reconstruction value of the prediction block in the template region.

In this embodiment, for the process of performing chroma intra prediction on the template region according to the cross-component prediction merge fusion mode, the decoder may predict based on the template region using each preset chroma prediction mode among at least one preset chroma prediction mode to obtain a prediction value corresponding to each preset chroma prediction mode. The decoder fuses the prediction value corresponding to each preset chroma prediction mode with the aforementioned prediction value corresponding to the cross-component prediction merge mode, respectively, to obtain a prediction value corresponding to each fusion scheme. Here, each fusion scheme refers to a combination of each preset chroma prediction mode with the cross-component prediction merge mode. The decoder compares the prediction value corresponding to each fusion scheme with the reconstruction value of the prediction block in the template region to determine the second cost value corresponding to the cross-component prediction merge fusion mode.
S202: whether the current block uses the cross-component prediction merge fusion mode is determined based on the first cost value and the second cost value.

In this embodiment, the decoder may determine whether the current block uses the cross-component prediction merge fusion mode based on a comparison of the magnitude of the first cost value and the second cost value. For example, when the second cost value is less than the second cost value (Translator's note: This appears to be a typo in the original Chinese text; it likely should be “when the second cost value is less than the first cost value”), it indicates that the prediction effect of the cross-component prediction merge fusion mode is better, and the decoder determines that the current block uses the cross-component prediction merge fusion mode. When the first cost value is less than the second cost value, it indicates that the prediction effect of the cross-component prediction merge mode is better, and the decoder determines that the current block does not use the cross-component prediction merge fusion mode.
S203: if it is determined that the current block uses the cross-component prediction merge fusion mode, the bitstream is parsed to determine at least one fusion type identification value corresponding to the current block.

In this embodiment, if the decoder determines that the current block uses the cross-component prediction merge fusion mode, it can further parse the bitstream to determine the at least one fusion type identification value, and then implement the chroma intra prediction under the cross-component prediction merge fusion mode provided by this embodiment by performing the methods in the aforementioned S104-S107.

It can be understood that this embodiment adaptively selects whether to use the cross-component prediction merge fusion mode based on a template matching method, without needing to transmit the second syntax identification information in the bitstream to determine whether to use the cross-component prediction merge fusion mode, thereby improving the bit rate and encoding/decoding efficiency.

In some embodiments, in a case where the current block uses the cross-component prediction merge fusion mode, the decoder may determine at least one chroma prediction mode corresponding to the current block based on chroma intra prediction on the template region of the current block.

In this embodiment, the situation of determining that the current block uses the cross-component prediction merge fusion mode may include: determining that the current block uses the cross-component prediction merge fusion mode according to the indication of the second syntax identification information in the bitstream; or, determining that the current block uses the cross-component prediction merge fusion mode according to the prediction method based on the template region described in the aforementioned S201-S202.

In some embodiments, for the case where it is determined that the current block uses the cross-component prediction merge fusion mode according to the indication of the second syntax identification information in the bitstream, the decoder may determine a template region corresponding to the current block, and perform prediction on the template region using the cross-component prediction merge mode and at least one preset chroma prediction mode to determine a cost value corresponding to each fusion scheme. The process is consistent with the corresponding description in S201-S202 and will not be repeated here. The decoder may determine at least one fusion scheme with a smaller cost value based on the cost value corresponding to each fusion scheme, and then determine at least one chroma prediction mode based on the preset chroma prediction mode(s) in the at least one fusion scheme.

In some embodiments, for the case where it is determined that the current block uses the cross-component prediction merge fusion mode according to the prediction method based on the template region described in the aforementioned S201-S202, the decoder may directly use the already predicted cost values corresponding to each fusion scheme to determine at least one fusion scheme with a smaller cost value, and then determine at least one chroma prediction mode based on the preset chroma prediction mode(s) in the at least one fusion scheme.

It can be understood that this embodiment adaptively selects at least one chroma prediction mode to fuse with the cross-component prediction merge mode based on a template matching method, without needing to transmit the fusion type identification value in the bitstream to determine which chroma prediction mode(s) to fuse with the cross-component prediction merge mode, thereby improving the bit rate and encoding/decoding efficiency.

In some embodiments, the process of the decoder performing chroma intra prediction on the current block using the cross-component prediction merge mode to determine the second prediction value may include:
determining an index identification value of the current block, and constructing a parameter candidate list for the current block; determining model parameters of the current block based on the parameter candidate list and the index identification value; and determining the second prediction value based on the model parameters and the reconstructed luma pixels corresponding to the current block.

In this embodiment, the index identification value is used to specify the model parameters corresponding to the current block in the parameter candidate list of the current block.

In some embodiments, if the first syntax identification information indicates that the current block uses the cross-component prediction merge mode, the decoder may determine the index identification value of the current block by parsing the bitstream. For example, the index identification value may be cclmMrgIdx.

In some embodiments, the idxNonLocalCCP flag can also be used as the index identification value. The value of idxNonLocalCCP is an integer between 0 and 12, with a minimum of 0 and a maximum of 12. When the value of idxNonLocalCCP is 0, the current block does not use the cross-component prediction merge mode; when the value of idxNonLocalCCP is not 0, the model parameters of the current block are obtained from the constructed parameter candidate list based on the value of idxNonLocalCCP. For example, the model parameters may be ccmList[idxNonLocalCCP−1].

In this embodiment, the aforementioned process of constructing the parameter candidate list for the current block may include:
determining adjacent blocks of the current block; if at least one block among the adjacent blocks uses a cross-component prediction mode or the cross-component prediction merge mode, determining respective model parameters of the at least one block to obtain at least one set of first candidate model parameters; and populating the parameter candidate list with the at least one set of first candidate model parameters.

It should be noted that in this embodiment, adjacent blocks may include: blocks spatially adjacent to the current block, and/or, blocks temporally adjacent to the current block. That is to say, the adjacent blocks here may be spatially adjacent blocks, or they may be temporally adjacent blocks. Spatially adjacent blocks are located in the same frame as the current block, while temporally adjacent blocks are located in different frames from the current block. For example, in the case of inter prediction, the adjacent blocks here may refer to temporally adjacent blocks located on a reference frame.

It should also be noted that, taking spatial adjacency as an example, the positions of adjacent blocks of the current block can be as shown in FIG. 6, and the checking order may be B1->A1->B0->A0->B2, following this order to determine at least one set of first candidate model parameters.

Furthermore, after populating the parameter candidate list with the at least one set of first candidate model parameters, if the parameter candidate list is not full, then in some embodiments, constructing the parameter candidate list for the current block may further include: determining non-adjacent blocks of the current block; if at least one block among the non-adjacent blocks uses a cross-component prediction mode or the cross-component prediction merge mode, determining respective model parameters of the at least one block to obtain at least one set of second candidate model parameters; continuing to populate the parameter candidate list with the at least one set of second candidate model parameters.

It should also be noted that in this embodiment, the number of candidates in the parameter candidate list is denoted by NUM_LMC_MERGE_CANDS. By default, the value of NUM_LMC_MERGE_CANDS is set to 12. If the number of first candidate model parameters is less than 12, it indicates that the parameter candidate list is not full; at this time, at least one set of second candidate model parameters needs to be determined based on the non-adjacent blocks of the current block, and then the at least one set of second candidate model parameters is continued to be populated into the parameter candidate list. For example, the positions of spatially non-adjacent blocks of the current block can be as shown in FIG. 7.

Furthermore, after populating the parameter candidate list with the at least one set of second candidate model parameters, if the parameter candidate list is not full, then in some embodiments, constructing the parameter candidate list for the current block may further include: determining at least one set of third candidate model parameters from a historical parameter candidate list; continuing to populate the parameter candidate list with the at least one set of third candidate model parameters.

It should be noted that in this embodiment, the decoder maintains a historical parameter candidate list, which contains recently used model parameters (ccmParam), and this table is reset at the beginning of each CTU row. If the current list is not full after including spatial adjacent and non-adjacent candidates, ccmParam from the historical parameter candidate list is added to the parameter candidate list.

Furthermore, after populating the parameter candidate list with the at least one set of second candidate model parameters, or after populating the parameter candidate list with the at least one set of third candidate model parameters, if the parameter candidate list is not full, then in some embodiments, constructing the parameter candidate list for the current block may further include: determining at least one set of fourth candidate model parameters based on preset parameter information; continuing to populate the parameter candidate list with the at least one set of fourth candidate model parameters.

It should be noted that in this embodiment, the preset parameter information may at least include preset values for first model parameters, and the preset values for the first model parameters are at least one of the following: 0, 1/8, −1/8, 2/8, −2/8, or 3/8.

It should also be noted that in some embodiments, the model parameters of the current block may include a first model parameter and a second model parameter. Here, the first model parameter may be used to indicate a scaling parameter when the current block uses the cross-component prediction mode or the cross-component prediction merge mode, and the second model parameter may be used to indicate an offset parameter when the current block uses the cross-component prediction mode or the cross-component prediction merge mode.

That is to say, after constructing the parameter candidate list based on the adjacent and non-adjacent blocks of the current block, if the constructed parameter candidate list is not full, then CCLM candidates with default scaling parameters can be considered. The default scaling parameters may be {0, 1/8, −1/8, 2/8, −2/8, 3/8}. It should be noted that for these default scaling parameters, they may be added to the parameter candidate list in the order of 0, 1/8, −1/8, 2/8, −2/8, 3/8.

It can also be understood that in this embodiment, the cross-component prediction mode may include at least one of the following: cross-component linear model prediction mode, MMLM mode, convolutional cross-component model mode, GLM mode, or chroma fusion mode. Here, the cross-component linear model prediction mode includes at least one of: CCLM mode, CCLM-T mode, or CCLM-L mode; the convolutional cross-component model mode includes at least one of: CCCM mode, CCCM-T mode, or CCCM-L mode. That is to say, the inherited mode here may be any cross-component prediction mode among cross-component linear model prediction mode, MMLM mode, convolutional cross-component model mode, GLM mode, chroma fusion mode, and CCMerge mode, which is not specifically limited here.

In some embodiments, determining the model parameters of the current block based on the parameter candidate list and the index identification value may include: in the parameter candidate list, determining a set of candidate model parameters corresponding to the index identification value; determining an inherited mode of the current block and the corresponding candidate model parameters based on the set of candidate model parameters; determining the model parameters of the current block based on the inherited mode of the current block and the candidate model parameters.

Further, in some embodiments, determining the model parameters of the current block based on the inherited mode of the current block and the candidate model parameters may include:
If the inherited mode of the current block is a cross-component linear model prediction mode, determining the first model parameter and the second model parameter in the candidate model parameters as the model parameters of the current block, i.e., determining that the current block inherits the first model parameter and the second model parameter from the candidate model parameters; where the first model parameter is used to indicate the scaling parameter of the cross-component prediction mode or the cross-component prediction merge mode, such as a in formula (1); the second model parameter is used to indicate the offset parameter of the cross-component prediction mode or the cross-component prediction merge mode, such as b in formula (1);
If the inherited mode of the current block is MMLM mode, determining the first model parameter and the classification threshold in the candidate model parameters as the model parameters of the current block, i.e., determining that the current block inherits the first model parameter and the classification threshold from the candidate model parameters;
If the inherited mode of the current block is CCCM mode, determining the convolution parameters and the classification threshold in the candidate model parameters as the model parameters of the current block, i.e., determining that the current block inherits the convolution parameters and the classification threshold from the candidate model parameters;
If the inherited mode of the current block is GLM mode, then when the GLM mode is a three-parameter mode, determining the gradient index value, the first model parameter, and the second model parameter in the candidate model parameters as the model parameters of the current block; or, when the GLM mode is a two-parameter mode, determining the model parameters of the current block based on the first model parameter in the candidate model parameters. That is, when the GLM mode is a three-parameter mode, determining that the current block inherits the gradient index value, the first model parameter, and the second model parameter from the candidate model parameters; or, when the GLM mode is a two-parameter mode, determining that the current block inherits the first model parameter from the candidate model parameters;
If the inherited mode of the current block is a chroma fusion mode, then when the chroma fusion mode is a chroma fusion derived mode, determining the prediction mode inherited by the current block, and determining the model parameters of the current block based on the prediction mode inherited by the current block and the candidate model parameters; or, when the chroma fusion mode is not a chroma fusion derived mode, determining that the current block uses the MMLM mode, and determining that the current block inherits the first model parameter and the classification threshold from the candidate model parameters;
If the inherited mode of the current block is CCMerge mode, determining the prediction mode inherited by the current block, and determining the model parameters of the current block based on the prediction mode inherited by the current block and the candidate model parameters.

Specifically, in this embodiment, the sources of cross-component model parameters are increased here, providing multiple options for the cross-component prediction merge mode. The inheritance rules can be as follows:
1. When inheriting a CCLM mode, inherit the scaling parameter and the offset parameter.
2. When inheriting an MMLM mode, inherit the scaling parameter and the classification threshold.
3. When inheriting a CCCM mode, inherit all convolution parameters and the classification threshold.
4. When inheriting a GLM mode, if the GLM is a 3-parameter mode, inherit all gradient indices and model parameters; otherwise, if the GLM is a 2-parameter mode, only inherit the scaling parameter, and the offset parameter needs to be recalculated.
5. When inheriting a chroma fusion mode, the MMLM parameters derived from the cross-component prediction part are inherited as candidates.
6. When inheriting a CCMerge mode, the inheritance method depends on the candidate mode it inherits.

It can also be understood that in this embodiment, regarding the size and construction process of the parameter candidate list, an independent set of rules can be used instead of sharing the rules of the cross-component prediction merge mode, which is not specifically limited here. Thus, after determining the model parameters of the current block according to the above inheritance rules, the target prediction value of the current block can be further determined.

In another embodiment of the present disclosure, referring to FIG. 13, it shows a flowchart of an encoding method provided by an embodiment of the present disclosure. As shown in FIG. 13, the method may include the following steps.
S301: a value of first syntax identification information is determined.

It should be noted that the encoding method of this embodiment is applied to an encoder. In addition, this encoding method can specifically refer to a chroma prediction method. Among chroma prediction modes, the improvement here is mainly for the cross-component prediction merge mode within chroma intra prediction modes. More specifically, it can be an improvement for the cross-component prediction merge fusion mode within the cross-component prediction merge mode, thereby enhancing the encoding performance of ECM.

It should also be noted that in this embodiment, the first syntax identification information is used to indicate whether the current block uses the cross-component prediction merge mode. Additionally, different values of the first syntax identification information indicate different mode situations accordingly.

In some embodiments, if the value of the first syntax identification information is a first value, it is determined that the first syntax identification information indicates that the current block does not use the cross-component prediction merge mode; if the value of the first syntax identification information is a second value, it is determined that the first syntax identification information indicates that the current block uses the cross-component prediction merge mode. In this embodiment, the first value and the second value are different. Here, the first value and the second value may be in parameter form or numeric form. Specifically, the first syntax identification information here may be a parameter written in the profile, or it may be the value of a flag, which is not specifically limited here.

For example, the first syntax identification information may be denoted as cclmMrgFlag. The first value may be set to 0, and the second value may be set to 1; alternatively, the first value may be set to false, and the second value may be set to true. If cclmMrgFlag is 0, it is used to instruct the decoder that the current block does not use the cross-component prediction merge mode. If cclmMrgFlag is 1, it is used to instruct the decoder that the current block uses the cross-component prediction merge mode.

In this embodiment, the encoder may perform chroma intra prediction on the current block through the cross-component prediction merge mode and at least one cross-component prediction mode respectively, to obtain a prediction value corresponding to the cross-component prediction merge mode and at least one prediction value corresponding to the at least one cross-component prediction mode. The encoder may determine whether to use the cross-component prediction merge mode for the current block by comparing the prediction value corresponding to the cross-component prediction merge mode with the at least one prediction value corresponding to the at least one cross-component prediction mode, thereby determining the first syntax identification information. The cross-component prediction mode may include at least one of: cross-component linear model prediction mode, MMLM mode, convolutional cross-component model mode, GLM mode, or chroma fusion mode.

Further, in some embodiments, the method may also include: encoding the value of the first syntax identification information, and writing the obtained encoding bits into the bitstream.

It should be noted that in this embodiment, the encoding side writes the value of the first syntax identification information into the bitstream, enabling the decoding side to directly determine the value of the first syntax identification information by decoding the bitstream, and thus determine whether the current block uses the cross-component prediction merge mode.

In some embodiments, when the encoder determines that the current block does not use the cross-component prediction merge mode by comparing the encoding cost between the cross-component prediction merge mode and at least one cross-component prediction mode, the prediction value corresponding to the cross-component prediction mode with the smaller encoding cost among the at least one cross-component prediction mode is determined as the chroma prediction value corresponding to the current block.
S302: if the first syntax identification information indicates that the current block uses the cross-component prediction merge mode, a value of second syntax identification information is determined.

In this embodiment, if the first syntax identification information indicates that the current block uses the cross-component prediction merge mode, i.e., the encoder determines to use the cross-component prediction merge mode for the current block. Then the encoder further determines whether the current block uses the cross-component prediction merge fusion mode by comparing encoding costs, thereby determining the value of the second syntax identification information.

In this embodiment, the second syntax identification information is used to indicate whether the current block uses the cross-component prediction merge fusion mode. In some embodiments, if the value of the second syntax identification information is a third value, it is determined that the second syntax identification information indicates that the current block does not use the cross-component prediction merge fusion mode; if the value of the second syntax identification information is a fourth value, it is determined that the second syntax identification information indicates that the current block uses the cross-component prediction merge fusion mode. In this embodiment, the third value and the fourth value are different. The third value may be the same as or different from the first value, and the fourth value may be the same as or different from the second value. Here, the third value and the fourth value may be in parameter form or numeric form. Specifically, the second syntax identification information here may be a parameter written in the profile, or it may be the value of a flag, which is not specifically limited here.

For example, the second syntax identification information may be denoted as ccpMergeFusionFlag. The third value may be set to 0, and the fourth value may be set to 1; alternatively, the third value may be set to false, and the fourth value may be set to true. If ccpMergeFusionFlag is 0, it is used to instruct the decoder that the current block does not use the cross-component prediction merge fusion mode. If cclmMrgFlag is 1, it is used to instruct the decoder that the current block uses the cross-component prediction merge fusion mode.

In this embodiment, the encoder may determine whether to use the cross-component prediction merge fusion mode for the current block by comparing the encoding cost between the cross-component prediction merge mode and the cross-component prediction merge fusion mode, thereby determining the second syntax identification information.

Further, in some embodiments, the method may also include: encoding the value of the second syntax identification information, and writing the obtained encoding bits into the bitstream.

In some embodiments, when the encoder determines that the current block does not use the cross-component prediction merge fusion mode by comparing encoding costs, the prediction value obtained by performing chroma intra prediction on the current block through the cross-component prediction merge mode is determined as the chroma prediction value corresponding to the current block.
S303: if the second syntax identification information indicates that the current block uses the cross-component prediction merge fusion mode, at least one chroma prediction mode corresponding to the current block is determined, and at least one fusion type identification value corresponding to the at least one chroma prediction mode is determined.

In this embodiment, if the second syntax identification information indicates that the current block uses the cross-component prediction merge fusion mode, it means that the encoder has determined to use the cross-component prediction merge fusion mode for the current block by comparing the encoding cost between the cross-component prediction merge mode and the cross-component prediction merge fusion mode. The process of the encoder comparing the encoding cost between the cross-component prediction merge mode and the cross-component prediction merge fusion mode may include:
performing chroma intra prediction on the current block using the cross-component prediction merge mode to determine a prediction value corresponding to the cross-component prediction merge mode; performing chroma intra prediction on the current block using at least one preset chroma prediction mode to determine at least one prediction value corresponding to the at least one preset chroma prediction mode; fusing each prediction value among the at least one prediction value with the prediction value corresponding to the cross-component prediction merge mode to obtain at least one fusion prediction value; determining at least one encoding cost based on the at least one fusion prediction value and the chroma value of the current block.

Here, the encoder may determine a first chroma prediction value corresponding to each preset chroma prediction mode among the at least one preset chroma prediction mode; determine an encoding cost corresponding to each preset chroma prediction mode based on the first chroma prediction value corresponding to each preset chroma prediction mode and the chroma value of the current block, thereby determining at least one encoding cost.

Here, since the at least one encoding cost is obtained by fusing each prediction value with the prediction value corresponding to the cross-component prediction merge mode, that is to say, the at least one encoding cost corresponds to the at least one preset chroma prediction mode. The decoder may determine the encoding cost corresponding to the cross-component prediction merge fusion mode based on the at least one encoding cost. For example, the minimum value among the at least one encoding cost may be determined as the encoding cost corresponding to the cross-component prediction merge fusion mode, and then by comparing the encoding cost corresponding to the cross-component prediction merge fusion mode with the encoding cost of the cross-component prediction merge mode, it is determined whether the current block uses the cross-component prediction merge fusion mode.

In this embodiment, when the encoder determines the cross-component prediction merge fusion mode, it may determine at least one chroma prediction mode from the at least one preset chroma prediction mode based on the already calculated at least one encoding cost. For example, the preset chroma prediction modes corresponding to the top n encoding costs with the smallest at least one encoding cost may be determined as the at least one chroma prediction mode. n is an integer not less than 1.

In this embodiment, the encoder may determine at least one fusion type identification value corresponding to the current block according to the at least one chroma prediction mode, in a preset correspondence between fusion type identification values and chroma prediction modes; wherein the preset correspondence between fusion type identification values and chroma prediction modes includes at least one preset fusion type identification value corresponding to at least one preset chroma prediction mode. Thus, on the decoder side, at least one first prediction value for chroma intra prediction of the current block based on the cross-component prediction merge fusion mode can be determined using the at least one fusion type identification value.

In this embodiment, the at least one preset chroma mode may include cross-component prediction modes and non-cross-component prediction modes. In some embodiments, the at least one preset chroma prediction mode includes at least one of: cross-component linear model prediction mode, MMLM mode, convolutional cross-component model mode, GLM mode, DIMD mode, or DM mode. Here, the cross-component linear model prediction mode includes at least one of: CCLM mode, CCLM-T mode, or CCLM-L mode; the convolutional cross-component model mode includes at least one of: CCCM mode, CCCM-T mode, or CCCM-L mode. The specific selection is made according to the actual situation and is not limited in this embodiment.

In some embodiments, after S303, the encoder may also determine at least one first chroma prediction value corresponding to the at least one chroma prediction mode based on the first chroma prediction value corresponding to each preset chroma prediction mode obtained during the encoding cost comparison process; perform chroma intra prediction on the current block using the cross-component prediction merge mode to determine a second prediction value; determine the chroma prediction value corresponding to the current block based on the at least one first prediction value and the second prediction value, thereby completing the processing of the cross-component prediction merge fusion mode at the encoder side and obtaining the chroma prediction value corresponding to the current block. Furthermore, the encoder determines a residual corresponding to the current block based on the chroma prediction value corresponding to the current block and the chroma value of the current block; generates encoding information corresponding to the current block based on the residual, the first syntax identification information, the second syntax identification information, and the at least one fusion type identification value, and writes it into the bitstream.

It can be understood that when the encoder determines that the current block uses the cross-component prediction merge mode, it further determines that the current block uses the cross-component prediction merge fusion mode, determines at least one chroma prediction mode to be fused with the cross-component prediction merge mode based on encoding cost, determines at least one fusion type identification value corresponding to the at least one chroma prediction mode and sends it to the decoder. Thus, based on the at least one fusion type identification value, the fusion mode on the decoding side can be flexibly specified, providing multiple choices for the cross-component prediction merge fusion mode, thereby improving the accuracy of chroma intra prediction and further enhancing encoding efficiency.

In some embodiments, if the first syntax identification information indicates that the current block uses the cross-component prediction merge mode, then based on a template region of the current block, perform chroma intra prediction according to the cross-component prediction merge mode and the cross-component prediction merge fusion mode respectively, to determine a first cost value corresponding to the cross-component prediction merge mode and a second cost value corresponding to the cross-component prediction merge fusion mode; determine whether the current block uses the cross-component prediction merge fusion mode based on the first cost value and the second cost value; if it is determined that the current block uses the cross-component prediction merge fusion mode, determine at least one fusion type identification value corresponding to the current block.

In this embodiment, the encoder can also adaptively select whether to use the cross-component prediction merge fusion mode based on a template matching method, without needing to transmit the second syntax identification information in the bitstream to determine whether to use the cross-component prediction merge fusion mode, in order to improve the bit rate and encoding efficiency. The process is consistent with the description in the decoder's S201-S203 and will not be repeated here.

In some embodiments, in a case where the current block uses the cross-component prediction merge fusion mode, determine at least one fusion type identification value corresponding to the current block based on chroma intra prediction on the template region of the current block.

In this embodiment, the encoder can also adaptively select at least one chroma prediction mode to fuse with the cross-component prediction merge mode based on a template matching method, without needing to transmit the fusion type identification value in the bitstream to determine which chroma prediction mode(s) to fuse with the cross-component prediction merge mode, in order to improve the bit rate and encoding efficiency. The process is consistent with the description of the same process in the decoder and will not be repeated here.

In short, this embodiment mainly provides a new fusion scheme for the cross-component prediction merge fusion mode. In this embodiment, the at least one chroma prediction mode used for fusion with the cross-component prediction merge mode in the cross-component prediction merge fusion mode can be specified by at least one fusion type identification value, thereby providing multiple choices for the fusion scheme and improving the efficiency of intra prediction encoding and decoding. For example, Table 1 shows test results of this embodiment. It can be seen that this embodiment can improve encoding and decoding efficiency, thereby enhancing encoding and decoding performance.

TABLE 1

| | All Intra Main 10 | | | | | |
|---|---|---|---|---|---|---|
| | Over anchor | | | | | |
| | Y | U | V | EncT | DecT | VmPeak |
| Class | −0.01% | −1.12% | −1.26% | 100.4% | 102.7% | 100.0% |
| A1 | | | | | | |
| Class | −0.10% | −0.67% | −0.64% | 101.1% | 101.8% | 100.0% |
| A2 | | | | | | |
| Class B | −0.01% | −0.67% | −0.83% | 100.9% | 101.3% | 100.0% |
| Class C | −0.02% | −0.38% | −0.29% | 100.9% | 100.5% | 100.0% |
| Class E | −0.02% | −0.49% | −0.81% | 100.8% | 100.4% | 100.0% |
| Overall | −0.03% | −0.65% | −0.74% | 100.9% | 101.3% | 100.0% |
| Class D | −0.02% | −0.14% | −0.28% | 101.0% | 100.3% | 100.0% |
| Class F | −0.02% | −0.20% | −0.14% | 100.2% | 100.1% | 100.0% |

In this embodiment, specific implementations of the aforementioned embodiments are elaborated through the above embodiments. It can be seen that, according to the technical solutions of the aforementioned embodiments, for the cross-component prediction merge fusion mode, at least one fusion type identification value is used to flexibly select chroma prediction modes available for fusion, providing multiple choices for the cross-component prediction merge fusion mode, thereby improving the accuracy of chroma intra prediction and further enhancing encoding and decoding efficiency.

In yet another embodiment of the present disclosure, based on the same inventive concept as the aforementioned embodiments, referring to FIG. 14, it shows a schematic structural diagram of an encoder provided by an embodiment of the present disclosure. As shown in FIG. 14, the encoder 130 may include: a first determination part 1301; wherein:

The first determination part 1301 is configured to determine a value of first syntax identification information; if the first syntax identification information indicates that a current block uses a cross-component prediction merge mode, determine a value of second syntax identification information.

The first determination part 1301 is further configured to, if the second syntax identification information indicates that the current block uses a cross-component prediction merge fusion mode, determine at least one chroma prediction mode corresponding to the current block, and determine at least one fusion type identification value corresponding to the at least one chroma prediction mode; the at least one fusion type identification value is used by a decoder to determine at least one first prediction value for chroma intra prediction of the current block based on the cross-component prediction merge fusion mode.

In some embodiments, the first determination part 1301 is further configured to determine at least one encoding cost corresponding to the at least one preset chroma prediction mode; determine the at least one chroma prediction mode from the at least one preset chroma prediction mode based on the at least one encoding cost.

In some embodiments, the at least one preset chroma prediction mode includes at least one of: cross-component linear model prediction mode, MMLM mode, convolutional cross-component model mode, GLM mode, DIMD mode, or DM mode.

In some embodiments, the first determination part 1301 is further configured to determine at least one fusion type identification value corresponding to the current block according to the at least one chroma prediction mode, in a preset correspondence between fusion type identification values and chroma prediction modes; the preset correspondence includes at least one preset fusion type identification value corresponding to at least one preset chroma prediction mode.

In some embodiments, the first determination part 1301 is further configured to determine a first chroma prediction value corresponding to each preset chroma prediction mode among the at least one preset chroma prediction mode; determine an encoding cost corresponding to each preset chroma prediction mode based on the first chroma prediction value corresponding to each preset chroma prediction mode and the chroma value of the current block, to determine the at least one encoding cost.

In some embodiments, referring to FIG. 14, the encoder 130 may further include a first prediction part 1303.

The first prediction part 1303 is configured to determine at least one first chroma prediction value corresponding to the at least one chroma prediction mode based on the first chroma prediction value corresponding to each preset chroma prediction mode; perform chroma intra prediction on the current block using the cross-component prediction merge mode to determine a second prediction value; determine a chroma prediction value corresponding to the current block based on the at least one first prediction value and the second prediction value.

In some embodiments, the first prediction part 1303 is further configured to perform weighted summation on the at least one first prediction value and the second prediction value according to at least two preset weights to determine a weighted sum value; determine a shift factor according to the at least two preset weights, and perform shifting on the weighted sum value according to the shift factor to determine the chroma prediction value.

In some embodiments, the first prediction part 1303 is further configured to, if the first syntax identification information indicates that the current block uses the cross-component prediction merge mode, then based on a template region of the current block, perform chroma intra prediction according to the cross-component prediction merge mode and the cross-component prediction merge fusion mode respectively, to determine a first cost value corresponding to the cross-component prediction merge mode and a second cost value corresponding to the cross-component prediction merge fusion mode; determine whether the current block uses the cross-component prediction merge fusion mode based on the first cost value and the second cost value; if it is determined that the current block uses the cross-component prediction merge fusion mode, determine at least one fusion type identification value corresponding to the current block.

In some embodiments, the first prediction part 1303 is further configured to, in a case where the current block uses the cross-component prediction merge fusion mode, determine at least one fusion type identification value corresponding to the current block based on chroma intra prediction on the template region of the current block.

In some embodiments, the first prediction part 1303 is further configured to, if it is determined that the current block does not use the cross-component prediction merge mode, determine the prediction value obtained by performing chroma intra prediction on the current block through a cross-component prediction mode as the chroma prediction value corresponding to the current block.

In some embodiments, the first prediction part 1303 is further configured to, if it is determined that the current block does not use the cross-component prediction merge fusion mode, determine the prediction value obtained by performing chroma intra prediction on the current block through the cross-component prediction merge mode as the chroma prediction value corresponding to the current block.

In some embodiments, referring to FIG. 14, the encoder 130 may further include an encoding part 1302.

The encoding part 1302 is configured to determine a residual corresponding to the current block based on the chroma prediction value corresponding to the current block and the chroma value of the current block; generate a bitstream based on the residual, the first syntax identification information, the second syntax identification information, and the at least one fusion type identification value.

It should be noted that the description of the above device embodiments is similar to the description of the aforementioned method embodiments and has similar beneficial effects as the method embodiments. For technical details not disclosed in the device embodiments of the present disclosure, please refer to the description of the method embodiments of the present disclosure.

It can be understood that in this embodiment, a “part” may be part of a circuit, part of a processor, part of a program or software, etc., and of course may also be a module, or it may be non-modular. Moreover, the various components in this embodiment may be integrated into one processing unit, or each unit may exist physically separately, or two or more units may be integrated into one unit. The aforementioned integrated unit may be implemented in the form of hardware or in the form of a software functional module.

If the integrated unit is implemented in the form of a software functional module and is not sold or used as an independent product, it can be stored in a computer-readable storage medium. Based on this understanding, the essence of the technical solution of this embodiment or the part contributing to the prior art or all or part of the technical solution may be embodied in the form of a software product, which is stored in a storage medium and includes several instructions for causing a computer device (which may be a personal computer, a server, a network device, etc.) or a processor to perform all or part of the steps of the method described in this embodiment. The aforementioned storage medium includes: U disk, mobile hard disk, Read-Only Memory (ROM), Random Access Memory (RAM), magnetic disk, or optical disk, and other various media capable of storing program codes.

Therefore, an embodiment of the present disclosure provides a storage medium (i.e., a computer-readable storage medium), applied to the encoder 130. The computer-readable storage medium stores a computer program, and when the computer program is executed by a first processor, the encoding method according to any one of the aforementioned embodiments is implemented.

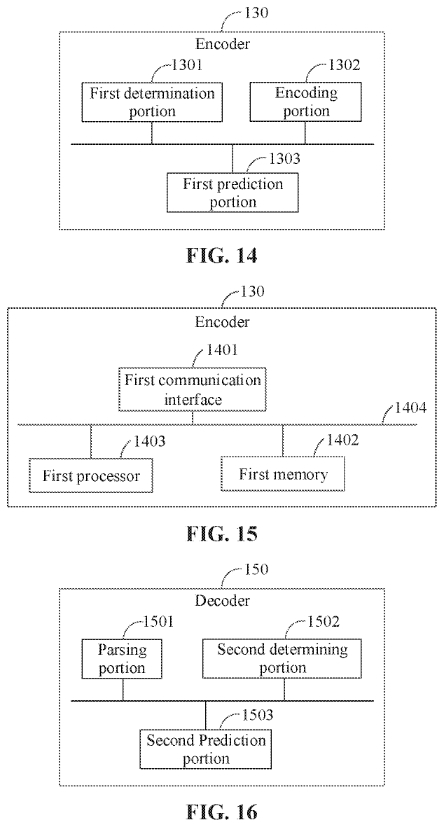

Based on the composition of the aforementioned encoder 130 and the computer-readable storage medium, referring to FIG. 15, it shows a schematic diagram of a specific hardware structure of an encoder provided by an embodiment of the present disclosure. As shown in FIG. 15, the encoder 130 may include: a first communication interface 1401, a first memory 1402, and a first processor 1403; each component is coupled together through a first bus system 1404. It can be understood that the first bus system 1404 is used to implement connection communication between these components. The first bus system 1404 includes not only a data bus but also a power bus, a control bus, and a status signal bus. However, for clarity of illustration, various buses are labeled as the first bus system 1404 in FIG. 15.

The first communication interface 1401 is used for receiving and sending signals during the process of transmitting and receiving information with other external network elements.

The first memory 1402 is used to store a computer program executable on the first processor 1403.

The first processor 1403 is configured to, when executing the computer program, perform:
determining a value of first syntax identification information;
if the first syntax identification information indicates that a current block uses a cross-component prediction merge mode, determining a value of second syntax identification information; and
if the second syntax identification information indicates that the current block uses a cross-component prediction merge fusion mode, determining at least one chroma prediction mode corresponding to the current block, and determining at least one fusion type identification value corresponding to the at least one chroma prediction mode; the at least one fusion type identification value is used by a decoder to determine at least one first prediction value for chroma intra prediction of the current block based on the cross-component prediction merge fusion mode.

It can be understood that the first memory 1402 in this embodiment may be volatile memory or non-volatile memory, or may include both volatile and non-volatile memory. Here, the non-volatile memory may be Read-Only Memory (ROM), Programmable Read-Only Memory (PROM), Erasable Programmable Read-Only Memory (EPROM), Electrically Erasable Programmable Read-Only Memory (EEPROM), or flash memory. The volatile memory may be Random Access Memory (RAM), which serves as an external high-speed cache. By way of example but not limitation, many forms of RAM are available, such as Static Random Access Memory (SRAM), Dynamic Random Access Memory (DRAM), Synchronous Dynamic Random Access Memory (SDRAM), Double Data Rate Synchronous Dynamic Random Access Memory (DDR SDRAM), Enhanced Synchronous Dynamic Random Access Memory (ESDRAM), Synchlink Dynamic Random Access Memory (SLDRAM), and Direct Rambus Random Access Memory (DRRAM). The first memory 1402 of the system and method described in the present disclosure is intended to include, but is not limited to, these and any other suitable types of memory.

The first processor 1403 may be an integrated circuit chip with signal processing capability. In the implementation process, the steps of the aforementioned methods may be completed by integrated logic circuits of hardware in the first processor 1403 or instructions in the form of software. The aforementioned first processor 1403 may be a general-purpose processor, a Digital Signal Processor (DSP), an Application Specific Integrated Circuit (ASIC), a Field Programmable Gate Array (FPGA) or other programmable logic device, discrete gate or transistor logic device, or discrete hardware component. It can implement or execute the methods, steps, and logic block diagrams disclosed in the embodiments of the present disclosure. A general-purpose processor may be a microprocessor, or the processor may be any conventional processor, etc. The steps of the method combined with the embodiments of the present disclosure may be directly embodied as being executed and completed by a hardware decoding processor, or executed and completed by a combination of hardware and software modules in the decoding processor. The software module may be located in a mature storage medium in the field such as random access memory, flash memory, read-only memory, programmable read-only memory, electrically erasable programmable memory, or registers. The storage medium is located in the first memory 1402, and the first processor 1403 reads information in the first memory 1402 and completes the steps of the aforementioned method in combination with its hardware.

It can be understood that the embodiments described in the present disclosure may be implemented in hardware, software, firmware, middleware, microcode, or a combination thereof. For hardware implementation, processing units may be implemented in one or more Application Specific Integrated Circuits (ASIC), Digital Signal Processors (DSP), Digital Signal Processing Devices (DSPD), Programmable Logic Devices (PLD), Field-Programmable Gate Arrays (FPGA), general-purpose processors, controllers, microcontrollers, microprocessors, other electronic units for performing the functions described in the present disclosure, or a combination thereof. For software implementation, the techniques described in the present disclosure may be implemented through modules (e.g., procedures, functions, etc.) that perform the functions described in the present disclosure. The software codes may be stored in a memory and executed by a processor. The memory may be implemented within the processor or external to the processor.

Optionally, as another embodiment, the first processor 1403 is further configured to, when executing the computer program, perform the encoding method according to any one of the aforementioned embodiments.

In yet another embodiment of the present disclosure, based on the same inventive concept as the aforementioned embodiments, referring to FIG. 16, it shows a schematic structural diagram of a decoder provided by an embodiment of the present disclosure. As shown in FIG. 16, the decoder 150 may include: a parsing part 1501, a second determination part 1502, and a second prediction part 1503.

Here, the parsing part 1501 is configured to parse a bitstream to determine a value of first syntax identification information; if the first syntax identification information indicates that a current block uses a cross-component prediction merge mode, parse the bitstream to determine a value of second syntax identification information; if the second syntax identification information indicates that the current block uses a cross-component prediction merge fusion mode, parse the bitstream to determine at least one fusion type identification value corresponding to the current block.

The second determination part 1502 is configured to determine at least one chroma prediction mode corresponding to the current block according to the at least one fusion type identification value.

The second prediction part 1503 is configured to perform chroma intra prediction on the current block using the at least one chroma prediction mode to determine at least one first prediction value; perform chroma intra prediction on the current block using the cross-component prediction merge mode to determine a second prediction value; determine a chroma prediction value corresponding to the current block based on the at least one first prediction value and the second prediction value.

In some embodiments, the second determination part 1502 is further configured to determine at least one chroma prediction mode corresponding to the current block according to the at least one fusion type identification value, in a preset correspondence between fusion type identification values and chroma prediction modes; the preset correspondence includes at least one preset fusion type identification value corresponding to at least one preset chroma prediction mode.

In some embodiments, the at least one preset chroma prediction mode includes at least one of: cross-component linear model prediction mode, MMLM mode, convolutional cross-component model mode, GLM mode, DIMD mode, or DM mode.

In some embodiments, the second prediction part 1503 is further configured to, if the first syntax identification information indicates that the current block does not use the cross-component prediction merge mode, perform chroma intra prediction on the current block through a cross-component prediction mode to determine the chroma prediction value corresponding to the current block.

In some embodiments, the second prediction part 1503 is further configured to, if the second syntax identification information indicates that the current block does not use the cross-component prediction merge fusion mode, perform chroma intra prediction on the current block through the cross-component prediction merge mode to determine the chroma prediction value corresponding to the current block.

In some embodiments, the second prediction part 1503 is further configured to perform weighted summation on the at least one first prediction value and the second prediction value according to at least two preset weights to determine a weighted sum value; determine a shift factor according to the at least two preset weights, and perform shifting on the weighted sum value according to the shift factor to determine the chroma prediction value.

In some embodiments, the second determination part 1502 is further configured to, if the first syntax identification information indicates that the current block uses the cross-component prediction merge mode, then based on a template region of the current block, perform chroma intra prediction according to the cross-component prediction merge mode and the cross-component prediction merge fusion mode respectively, to determine a first cost value corresponding to the cross-component prediction merge mode and a second cost value corresponding to the cross-component prediction merge fusion mode; determine whether the current block uses the cross-component prediction merge fusion mode based on the first cost value and the second cost value; if it is determined that the current block uses the cross-component prediction merge fusion mode, parse the bitstream to determine at least one fusion type identification value corresponding to the current block.

In some embodiments, the second determination part 1502 is further configured to, in a case where the current block uses the cross-component prediction merge fusion mode, determine at least one chroma prediction mode corresponding to the current block based on chroma intra prediction on the template region of the current block.

It should be noted that the description of the above device embodiments is similar to the description of the aforementioned method embodiments and has similar beneficial effects as the method embodiments. For technical details not disclosed in the device embodiments of the present disclosure, please refer to the description of the method embodiments of the present disclosure.

It can be understood that in this embodiment, a “part” may be part of a circuit, part of a processor, part of a program or software, etc., and of course may also be a module, or it may be non-modular. Moreover, the various components in this embodiment may be integrated into one processing unit, or each unit may exist physically separately, or two or more units may be integrated into one unit. The aforementioned integrated unit may be implemented in the form of hardware or in the form of a software functional module.

If the integrated unit is implemented in the form of a software functional module and is not sold or used as an independent product, it can be stored in a computer-readable storage medium. Based on this understanding, this embodiment provides a storage medium (i.e., a computer-readable storage medium), applied to the decoder 150. The computer-readable storage medium stores a computer program, and when the computer program is executed by a second processor, the decoding method according to any one of the aforementioned embodiments is implemented.

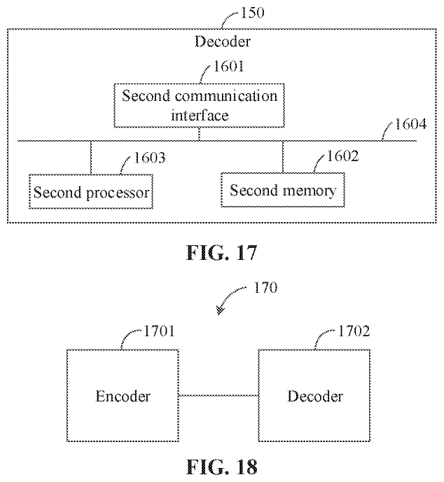

Based on the composition of the aforementioned decoder 150 and the computer-readable storage medium, referring to FIG. 17, it shows a schematic diagram of a specific hardware structure of a decoder provided by an embodiment of the present disclosure. As shown in FIG. 17, the decoder 150 may include: a second communication interface 1601, a second memory 1602, and a second processor 1603; each component is coupled together through a second bus system 1604. It can be understood that the second bus system 1604 is used to implement connection communication between these components. The second bus system 1604 includes not only a data bus but also a power bus, a control bus, and a status signal bus. However, for clarity of illustration, various buses are labeled as the second bus system 1604 in FIG. 17.

The second communication interface 1601 is used for receiving and sending signals during the process of transmitting and receiving information with other external network elements.

The second memory 1602 is used to store a computer program executable on the second processor 1603.

The second processor 1603 is configured to, when executing the computer program, perform:
parsing a bitstream to determine a value of first syntax identification information;
if the first syntax identification information indicates that a current block uses a cross-component prediction merge mode, parsing the bitstream to determine a value of second syntax identification information;
if the second syntax identification information indicates that the current block uses a cross-component prediction merge fusion mode, parsing the bitstream to determine at least one fusion type identification value corresponding to the current block;
determining at least one chroma prediction mode corresponding to the current block according to the at least one fusion type identification value;
performing chroma intra prediction on the current block using the at least one chroma prediction mode to determine at least one first prediction value;
performing chroma intra prediction on the current block using the cross-component prediction merge mode to determine a second prediction value; and
determining a chroma prediction value corresponding to the current block based on the at least one first prediction value and the second prediction value.

Optionally, as another embodiment, the second processor 1603 is further configured to, when executing the computer program, perform the decoding method according to any one of the aforementioned embodiments.

It can be understood that the hardware functions of the second memory 1602 are similar to those of the first memory 1402, and the hardware functions of the second processor 1603 are similar to those of the first processor 1403; they will not be detailed here.

In yet another embodiment of the present disclosure, referring to FIG. 18, it shows a schematic structural diagram of an encoding and decoding system provided by an embodiment of the present disclosure. As shown in FIG. 18, the encoding and decoding system 170 may include an encoder 1701 and a decoder 1702.

In this embodiment of the present disclosure, the encoder 1701 may be the encoder according to any one of the aforementioned embodiments, and the decoder 1702 may be the decoder according to any one of the aforementioned embodiments.

It should be noted that in the present disclosure, the terms “comprise”, “include”, or any other variants thereof are intended to cover non-exclusive inclusion, so that a process, method, article, or device that includes a series of elements includes not only those elements, but also other elements not explicitly listed, or elements inherent to such process, method, article, or device. Without further limitation, an element defined by the phrase “comprising a . . . ” does not preclude the existence of additional identical elements in the process, method, article, or device that includes the element.

The serial numbers of the embodiments of the present disclosure are for description only and do not represent the superiority or inferiority of the embodiments.

The methods disclosed in the several method embodiments provided by the present disclosure may be arbitrarily combined without conflict to obtain new method embodiments.

The features disclosed in the several product embodiments provided by the present disclosure may be arbitrarily combined without conflict to obtain new product embodiments.

The features disclosed in the several method or device embodiments provided by the present disclosure may be arbitrarily combined without conflict to obtain new method embodiments or device embodiments.

The above descriptions are only specific implementations of the present disclosure. However, the protection scope of the present disclosure is not limited thereto. Any person familiar with the technical field could readily think of changes or substitutions within the technical scope disclosed in the present disclosure, which should be covered within the protection scope of the present disclosure. Therefore, the protection scope of the present disclosure shall be subject to the protection scope of the claims.

### INDUSTRIAL APPLICABILITY

In the embodiments of the present disclosure, when the decoding side determines that the current block uses the cross-component prediction merge mode, it further determines that the current block uses the cross-component prediction merge fusion mode, can further parse at least one fusion type identification value corresponding to the current block sent by the encoding side from the bitstream, determines at least one chroma prediction mode corresponding to the current block according to the at least one fusion type identification value, and then fuses the at least one first prediction value obtained through prediction using the at least one chroma prediction mode with the second prediction value obtained through prediction using the cross-component prediction merge mode to determine the chroma prediction value corresponding to the current block. That is to say, based on the at least one fusion type identification value, the fusion mode on the decoding side can be flexibly selected, providing multiple choices for the cross-component prediction merge fusion mode, thereby improving the prediction accuracy of the chroma fusion mode and further enhancing decoding efficiency.

1. A decoding method, applied to a decoder, the method comprising:
parsing a bitstream to determine a value of first syntax identification information;
if the first syntax identification information indicates that a current block uses a cross-component prediction merge mode, determining a value of second syntax identification information;
if the second syntax identification information indicates that the current block uses a cross-component prediction merge fusion mode, determining at least one fusion type identification value corresponding to the current block;
determining at least one chroma prediction mode corresponding to the current block according to the at least one fusion type identification value;
performing chroma intra prediction on the current block using the at least one chroma prediction mode to determine at least one first prediction value;
performing chroma intra prediction on the current block using the cross-component prediction merge mode to determine a second prediction value; and
determining a chroma prediction value corresponding to the current block based on the at least one first prediction value and the second prediction value.

2. The method according to claim 1, wherein the determining at least one chroma prediction mode corresponding to the current block according to the at least one fusion type identification value comprises:
determining at least one chroma prediction mode corresponding to the current block in a preset correspondence between fusion type identification values and chroma prediction modes according to the at least one fusion type identification value; the preset correspondence comprises at least one preset fusion type identification value corresponding to at least one preset chroma prediction mode.

3. The method according to claim 1, wherein determining at least one fusion type identification value corresponding to the current block comprises:
determining a fusion type identification value corresponding to the current block;
and determining the at least one chroma prediction mode corresponding to the current block according to the at least one fusion type identification value comprises:
determining the chroma prediction mode corresponding to the current block according to the fusion type identification value corresponding to the current block.

4. The method according to claim 1, wherein the chroma prediction mode is a cross-component prediction mode or a non-cross-component prediction mode.

5. The method according to claim 1, wherein the chroma prediction mode is one of: a cross-component linear model prediction mode, an MMLM mode, a convolutional cross-component model mode, a GLM mode, a DIMD mode, or a DM mode.

6. The method according to claim 1, further comprising:
if the first syntax identification information indicates that the current block does not use the cross-component prediction merge mode, performing chroma intra prediction on the current block through a cross-component prediction mode to determine the chroma prediction value corresponding to the current block.

7. The method according to claim 1, further comprising:
if the second syntax identification information indicates that the current block does not use the cross-component prediction merge fusion mode, performing chroma intra prediction on the current block through the cross-component prediction merge mode to determine the chroma prediction value corresponding to the current block.

8. The method according to claim 1, wherein determining the chroma prediction value corresponding to the current block based on the at least one first prediction value and the second prediction value comprises:
determining a weighted sum value of the at least one first prediction value and the second prediction value; and
shifting the weighted sum value to determine the chroma prediction value corresponding to the current block.

9. The method according to claim 8, further comprising:
determining a shift factor according to weighting weights corresponding to the at least one first prediction value and the second prediction value; and
shifting the weighted sum value according to the shift factor to determine the chroma prediction value corresponding to the current block.

10. An encoding method, applied to an encoder, the method comprising:
determining a value of first syntax identification information;
if the first syntax identification information indicates that a current block uses a cross-component prediction merge mode, determining a value of second syntax identification information;
if the second syntax identification information indicates that the current block uses a cross-component prediction merge fusion mode, determining at least one chroma prediction mode corresponding to the current block, and determining at least one fusion type identification value corresponding to the at least one chroma prediction mode;
performing chroma intra prediction on the current block using the at least one chroma prediction mode to determine at least one first prediction value;
performing chroma intra prediction on the current block using the cross-component prediction merge mode to determine a second prediction value; and
determining a chroma prediction value corresponding to the current block based on the at least one first prediction value and the second prediction value.

11. The method according to claim 10, wherein the determining at least one chroma prediction mode corresponding to the current block comprises:
determining at least one encoding cost corresponding to the at least one preset chroma prediction mode; and
determining the at least one chroma prediction mode from the at least one preset chroma prediction mode based on the at least one encoding cost.

12. The method according to claim 10, wherein determining the at least one chroma prediction mode corresponding to the current block comprises:
determining a chroma prediction mode of the current block;
and determining the at least one fusion type identification value corresponding to the at least one chroma prediction mode comprises:
determining a fusion type identification value corresponding to the chroma prediction mode of the current block.

13. The method according to claim 10, wherein the chroma prediction mode is a cross-component prediction mode or a non-cross-component prediction mode.

14. The method according to claim 10, wherein the chroma prediction mode is one of: a cross-component linear model prediction mode, an MMLM mode, a convolutional cross-component model mode, a GLM mode, a DIMD mode, or a DM mode.

15. The method according to claim 10, wherein the determining at least one fusion type identification value corresponding to the at least one chroma prediction mode comprises:
determining at least one fusion type identification value corresponding to the current block in a preset correspondence between fusion type identification values and chroma prediction modes according to the at least one chroma prediction mode; wherein the preset correspondence comprises at least one preset fusion type identification value corresponding to at least one preset chroma prediction mode.

16. The method according to claim 11, wherein the determining at least one encoding cost corresponding to the at least one preset chroma prediction mode comprises:
determining a first chroma prediction value corresponding to each preset chroma prediction mode among the at least one preset chroma prediction mode; and
determining an encoding cost corresponding to each preset chroma prediction mode based on the first chroma prediction value corresponding to each preset chroma prediction mode and a chroma value of the current block, to determine the at least one encoding cost.

17. The method according to claim 10, wherein determining the chroma prediction value corresponding to the current block based on the at least one first prediction value and the second prediction value comprises:
determining a weighted sum value of the at least one first prediction value and the second prediction value; and
shifting the weighted sum value to determine the chroma prediction value corresponding to the current block.

18. The method according to claim 17, further comprising:
determining a shift factor according to weighting weights corresponding to the at least one first prediction value and the second prediction value; and
shifting the weighted sum value according to the shift factor to determine the chroma prediction value corresponding to the current block.

19. The method according to claim 10, further comprising:
determining a residual corresponding to the current block based on the chroma prediction value corresponding to the current block and a chroma value of the current block; and
generating a bitstream based on the residual, the first syntax identification information, the second syntax identification information, and the at least one fusion type identification value.

20. A computer-readable storage medium having stored thereon a computer program and a bitstream wherein when the computer program is executed by a processor, the computer program implements the method of claim 10 to generate a bitstream.
